(19) United States
(12) Patent Application Publication
(10) Pub. No.: US 2004/0161595 A1
(43) Pub. Date: Aug. 19, 2004

(54) Method of and apparatus for concrete construction

(76) Inventor: John B. Baines, Virginia Beach, VA (US)

Correspondence Address: Michael A. O'Neil, Michael A. O'Neil, P.C., 5949 Sherry Lane, Suite 820, Dallas, TX, 75225, US

(21) Appl. No.: 10/370,324

(22) Filed: Feb. 19, 2003

(51) Int. Cl. B32B 3/26; B32B 3/00; B32B 7/12

(52) U.S. Cl. 428/304.4; 428/317.1; 428/314.4

(57) ABSTRACT

Forms utilized in constructing concrete structures and expansion joints utilized in concrete structures are formed from closed cell polymeric foam. The forms and expansion joints may comprise a single layer or multiple layers joined by heat sealing or by means or a suitable adhesive. A reinforcing layer comprising mesh or sheet material may be positioned between the layers comprising the form or expansion joint.

### TECHNICAL FIELD

This invention relates generally to the construction of concrete sidewalks, concrete driveways, and other concrete structures, and more particularly to improvements in the design and construction of forming systems and in the design and construction of expansion joints used in concrete construction.

### BACKGROUND AND SUMMARY OF THE INVENTION

The construction of concrete sidewalks, concrete driveways, and similar concrete structures typically involves the use of forms which are deployed along the opposite edges of the concrete structure to be formed. Reinforcing members, which may comprise re-bar, wire mesh, etc., are deployed between the forms. When the reinforcing members are in place, concrete is poured into the space between the forms and is allowed to cure. When curing is complete, the forms are removed and the concrete structure is ready for use.

Heretofore the forms utilized in concrete construction have typically been manufactured from wood, with both conventional lumber and plywood having been used in the manufacture of concrete forms. Although generally satisfactory insofar as the end result is concerned, the use of wooden forms for concrete construction inherently includes numerous drawbacks. First, wooden concrete forms are heavy and therefore require the use of large trucks to transport the forms to and from the construction site, and further require the use of multiple personnel to transport the forms from the delivery point to the location at which they will actually be used. Second, due to environmental and other concerns, the cost of using wooden forms for concrete construction has risen steadily over the years. Third, saws, usually power saws, are required to cut wooden forms to length or otherwise adapt wooden forms to particular applications.

The present invention comprises a method of and apparatus for concrete forming which overcomes the foregoing and other difficulties which have long since been associated with the prior art. In accordance with the broader aspects of the invention, concrete forms are formed from closed cell polymeric material. Concrete forms constructed in accordance with the invention weigh between about one fifth and about one tenth as much as wooden concrete forms, meaning that pickup trucks and similar light duty vehicles can be utilized to transport the concrete forms to the building site, and a single individual can carry a large number of the forms from the delivery site to the point of construction. Additionally, concrete forms constructed in accordance with the invention can be cut to length using pocket knives or similar cutting instruments thereby substantially improving the efficiency of concrete form construction.

The construction of concrete sidewalks, driveways, and similar concrete structures also involves the use of expansion joints which are positioned at spaced apart intervals along the length of the concrete structure to allow for thermal expansion, etc. Heretofore expansion joints have been formed from wood, plastic, and other natural and synthetic materials. In accordance with the present invention expansion joints utilized in concrete construction are formed from closed cell polymeric foam materials. Expansion joints comprising the present invention are both more economical to use and easier to install as compared with prior art expansion joint designs.

### BRIEF DESCRIPTION OF THE DRAWINGS

A more complete understanding of the present invention may be had by reference to the following Detailed Description when taken in connection with the accompanying Drawings, wherein:

FIG. 1 is a partial perspective view illustrating a first embodiment of the invention;

FIG. 2 is a side view illustrating a second embodiment of the invention in which certain parts have been broken away more clearly to illustrate certain features of the invention;

FIG. 3 is a side view similar to FIG. 2 illustrating a third embodiment of the invention in which certain parts have been broken away to more fully illustrate certain features of the invention;

FIG. 4 is a partial perspective view illustrating a fourth embodiment of the invention;

FIG. 5 is a partial perspective view illustrating the fifth embodiment of the invention;

FIG. 6 is a partial perspective view illustrating the method and apparatus of the present invention; and

FIG. 7 is a partial perspective view illustrating the method and apparatus of the present invention.

### DETAILED DESCRIPTION

Referring now to the Drawings, and particularly to FIG. 1 thereof, there is shown a section of concrete forming material 10 comprising a first embodiment of the invention. The section of concrete forming material 10 comprises closed cell foam formed from a polymeric material. The polymeric material utilized in the manufacture of the concrete forming material 10 may be polyethylene, polypropylene, mixtures or blends of polyethylene and polypropylene, polystyrene, or any other selected polymeric material depending upon the requirements of particular applications of the invention.

The section of concrete forming material 10 has a predetermined thickness T which typically is about ½ inch. The section of concrete forming material 10 further comprises a predetermined height H. When the section of concrete forming material 10 is intended for utilization in the construction of concrete sidewalks the height H will typically be about four inches or more. When the section of concrete forming material 10 is intended for utilizing the construction of driveways the height H will typically be about six inches or more. When the section of concrete forming material 10 is intended for utilization and construction of other concrete structures, the height H will depend upon the dimensions of the concrete structure to be formed.

An important consideration in determining the thickness T and the height H of concrete forms comprising the present invention is the fact that when oriented to stand upright on one of the narrow edges thereof the forms must have sufficient rigidity to support a screed of the type used in concrete construction. As is well known to those skilled in the art, a screed is a device used to smooth and level the upper or outer surface of a quantity of concrete following pouring and prior to curing thereof. The requirement that concrete forms constructed in accordance with the invention have sufficient rigidity to support the screed during smoothing and leveling of concrete contained by the forms is common to all embodiments of the invention.

The section of concrete forming material 10 further comprises a length L which is not critical to the practice of the invention but typically is ten feet, twelve feet, or more. As will be apparent to those skilled in the art, the length L of the section of concrete forming material 10 ultimately depends upon the requirements of particular applications of the invention.

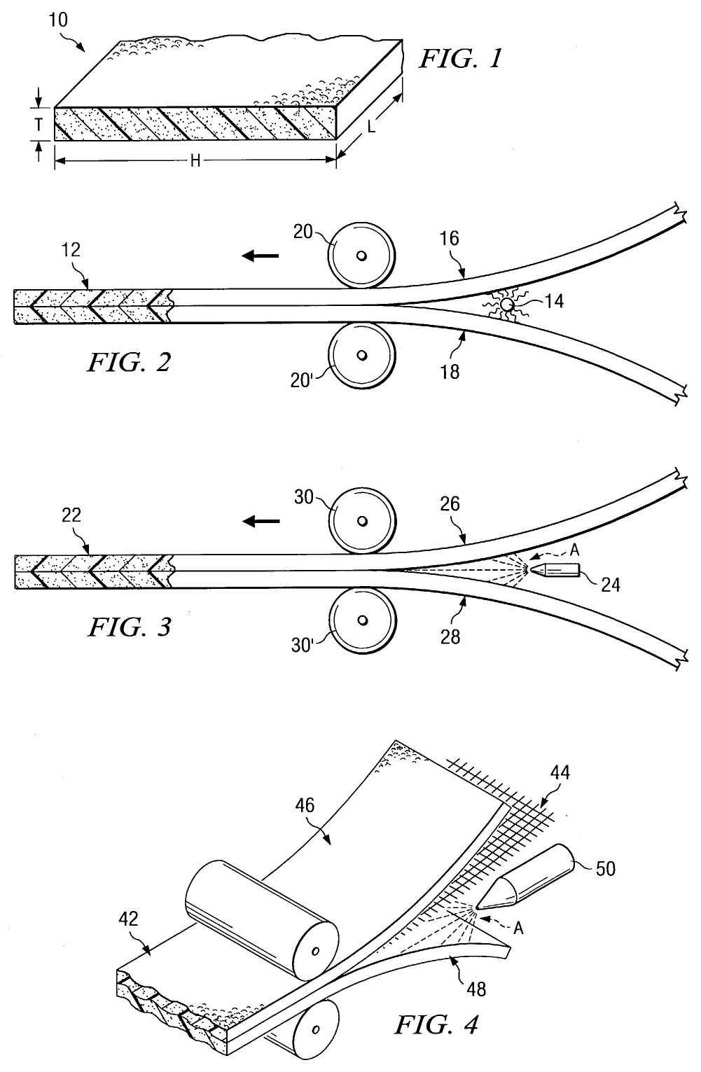

As will be apparent from FIG. 1, the section of concrete forming material 10 comprises a unitary layer. In some instances the construction of concrete forming material incorporating the invention in the form of a single layer may be problematic. Referring to FIG. 2, there is shown a section of concrete forming material 12 comprising a two layer construction. The length of concrete forming material 12 is substantially identical to the length of concrete forming material 10 of FIG. 1 except that it comprises two layers.

In the construction of the section of concrete forming material 12 a hot air knife 14 is positioned between the layers 16 and 18. Each of the layers 16 and 18 is comprised entirely of closed cell polymeric foam. For example, the layers 16 and 18 may comprise closed cell polyethylene foam, closed cell polypropylene foam, etc. depending upon the requirements of particular embodiments of the invention.

The hot air knife 14 heats the adjacent surfaces of the layers 16 and 18 to the melting point, or at least sufficiently to cause substantial softening thereof. The layers 16 and 18 then pass between rollers 20 and 20′ whereby the layers 16 and 18 are permanently joined one to another to form the section of concrete forming material 12. Upon joinder of the layers 16 and 18 the section of concrete forming material 12 is substantially identical to the section of concrete forming material 10 of FIG. 1 except that the existence of the bonding layer formed between the layers 16 and 18 under the action of the hot air knife 14 may impart additional resistance to bending to the section of concrete forming material 12 as compared with the section of concrete forming material 10.

Referring to FIG. 3, there is shown a section of concrete forming material 22 comprising a two layer construction. The length of concrete forming material 22 is substantially identical to the length of concrete forming material 10 of FIG. 1 except that it comprises two layers.

In the construction of the section of concrete forming material 22 a nozzle 24 is positioned between the layers 26 and 28. Each of the layers 26 and 28 is comprised entirely of closed cell polymeric foam. For example, the layers 26 and 28 may comprise closed cell polyethylene foam, closed cell polypropylene foam, etc. depending upon the requirements of particular embodiments of the invention.

The nozzle 24 deposits an adhesive A on the adjacent surfaces of the layers 26 and 28. The layers 26 and 28 then pass between rollers 30 and 30′ whereby the layers 26 and 28 are permanently joined one to another to form the section of concrete forming material 22. Upon joinder of the layers 26 and 28 the section of concrete forming material 22 is substantially identical to the section of concrete forming material 10 of FIG. 1 except that the existence of the bonding layer formed between the layers 26 and 28 under the action of the adhesive A may impart additional resistance to bending to the section of concrete forming material 22 as compared with the section of concrete forming material 10.

Referring to FIG. 4 there is shown a section of concrete forming material 42 comprising a fourth embodiment of the invention. The section of concrete forming material 42 comprises a two layer construction which is similar in many respects to the section of concrete forming material 12 illustrated in FIG. 2 and described hereinabove in conjunction therewith and to the section of concrete forming material 22 shown in FIG. 3 and described hereinabove in conjunction therewith.

The section of concrete forming material 42 differs from the section of concrete forming material 12 and the section of concrete forming material 22 in that it includes a reinforcing layer 44. The reinforcing layer 44 may comprise a mesh formed from metal, an elastomeric material, fiberglass, etc. depending upon the requirements of particular applications of the invention. The section of concrete forming material 42 further comprises opposed layers 46 and 48 each formed from a closed cell polymeric foam which may comprise polyethylene foam, polypropylene foam, etc. depending upon the requirements of particular applications of the invention.

The layers 46 may be joined one to another with the layer 44 sandwiched therebetween by an adhesive A discharged from a nozzle 50 in the manner illustrated in FIG. 3 and described hereinabove in conjunction therewith. Alternatively, the section of concrete forming material 42 may be formed by securing the layers 46 and 48 one to another with the layer 44 sandwiched therebetween utilizing a hot air knife as illustrated in FIG. 2 and described hereinabove in conjunction therewith.

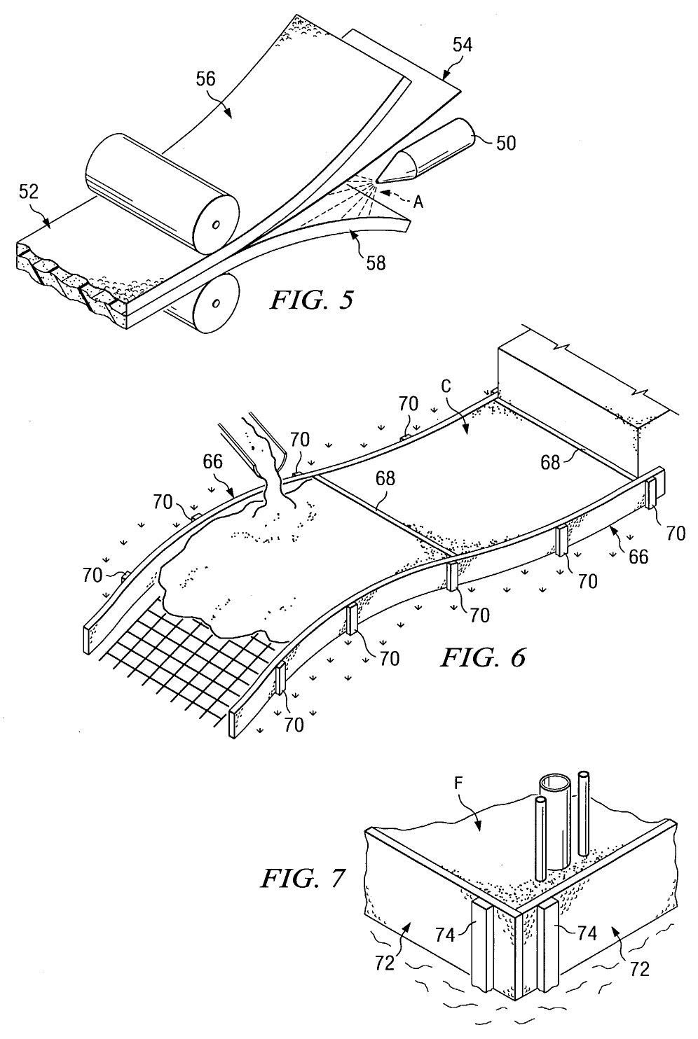

Referring to FIG. 5 there is shown a section of concrete forming material 52 comprising a fourth embodiment of the invention. The section of concrete forming material 52 comprises a two layer construction which is similar in many respects to the section of concrete forming material 12 illustrated in FIG. 2 and described hereinabove in conjunction therewith and to the section of concrete forming material 52 shown in FIG. 3 and described hereinabove in conjunction therewith.

The section of concrete forming material 52 differs from the section of concrete forming material 12 and the section of concrete forming material 22 in that it includes a reinforcing layer 54. The reinforcing layer 54 may comprise a sheet formed from metal, an elastomeric material, fiberglass, etc. depending upon the requirements of particular applications of the invention. The section of concrete forming material 52 further comprises opposed layers 56 and 58 each formed from a closed cell polymeric foam which may comprise polyethylene foam, polypropylene foam, etc. depending upon the requirements of particular applications of the invention. The layers 56 may be joined one to another with the layer 54 sandwiched therebetween by an adhesive A discharged from a nozzle 50 in the manner illustrated in FIG. 3 and described hereinabove in conjunction therewith. Alternatively, the section of concrete forming material 52 may be formed by securing the layers 56 and 58 one to another with the layer 54 sandwiched therebetween utilizing a hot air knife as illustrated in FIG. 2 and described hereinabove in conjunction therewith.

The manufacturing techniques illustrated in FIGS. 1 through 5, inclusive, and described hereinabove in conjunction therewith may also be utilized in the manufacture of expansion joints for concrete structures. The expansion joints are substantially identical in construction and function to the sections of concrete forming material described hereinabove except that the length of the expansion joints is typically substantially less than the lengths of the sections of concrete forming material. The expansion joints of the present invention may be provided either in a selected of predetermined lengths, or they may be easily cut to length in the field utilizing pocket knives and similar cutting instruments.

Referring to FIG. 6, there is shown a concrete structure C which is constructed utilizing forms 66 and expansion joints 68 manufactured in accordance with the present invention. The forms 66 may be formed as illustrated in FIG. 1 and described hereinabove in conjunction therewith, or as illustrated in FIG. 2 and described hereinabove in conjunction therewith or as illustrated in FIG. 3 and described hereinabove in conjunction therewith, or as illustrated in FIG. 4 and described hereinabove in conjunction therewith, or as illustrated in FIG. 5 and described hereinabove in conjunction therewith. Regardless of the technique which is utilized in the manufacture of the forms 66, the forms 66 has sufficient flexibility to adapt readily to the construction of concrete structures which are curvilinear in shape. Alternatively, the forms 66 may be utilized to construct a concrete structure having sides which are straight and parallel. In either event the concrete forms 66 are retained in place by retaining members 70 formed from wood, plastic, metal or the like which are driven into the underlying surface S in the conventional manner.

As indicated hereinabove, the expansion joints 68 of the concrete construction C may be fabricated as illustrated in FIG. 1 and described hereinabove in conjunction therewith, or as illustrated in FIG. 2 and described hereinabove in conjunction therewith, or as illustrated in FIG. 3 and described hereinabove in conjunction therewith, or as illustrated in FIG. 4 and described hereinabove in conjunction therewith, or as illustrated in FIG. 5 and described hereinabove in conjunction therewith. As will be appreciated by those skilled in the art, the expansion joints 68 typically extend perpendicularly to the forms 66 and are positioned at spaced apart intervals along the length of the concrete construction C.

Referring to FIG. 7, concrete forms 72 may be utilized in the construction of the concrete foundation slab F which in many instances will be substantially thicker than a sidewalk or a driveway. Also, the concrete foundation slab F is typically rectilinear in shape and is characterized by straight sides extending perpendicularly to one another. The concrete forms 72 of the present invention utilized in the construction of the foundation slab F may be manufactured as illustrated in FIG. 1 and described hereinabove in conjunction therewith, or as illustrated in FIG. 2 and described hereinabove in conjunction therewith, or as illustrated in FIG. 3 and described hereinabove in conjunction therewith, or as illustrated in FIG. 4 and described hereinabove in conjunction therewith, or as illustrated in FIG. 5 and described hereinabove in conjunction therewith. In any event, the concrete forms 72 are typically retained in place by spikes or stakes 74 which may be formed from wood, plastic, metal, or any other desired material and which are typically driven into the underlying surface to retain the forms 72 in place which the concrete comprising the foundation slab F is poured and cured.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A concrete form comprising:
a body of closed cell polymeric foam having a predetermined thickness, a predetermined height, and an indeterminate length;
the body of closed cell polymeric foam having a substantially uniform thickness and a substantially uniform height throughout the entire length thereof.

2. The concrete form according to claim 1 wherein the closed cell polymeric foam is formed from polyethylene.

3. The concrete form according to claim 1 wherein the closed cell polymeric foam is formed from polypropylene.

4. The concrete form according to claim 1 wherein the closed cell polymeric foam is formed from a blend of polyethylene and polypropylene.

5. The concrete form according to claim 1 wherein the closed cell polymeric foam is formed from polystyrene.

6. The concrete form according to claim 1 wherein the body of polymeric foam comprises a unitary structure throughout the entire thickness thereof.

7. The concrete form according to claim 1 wherein the body of polymeric foam comprises first and second layers formed from the same closed cell polymeric foam material which are joined one to another along the entire length thereof.

8. The concrete form according to claim 7 wherein the first and second layers are formed from the same material.

9. The concrete form according to claim 7 wherein the layers of polymeric foam are joined one to another by heat sealing.

10. The concrete form according to claim 7 wherein the layers of polymeric foam are joined one to another by depositing a layer of adhesive material therebetween.

11. The concrete form according to claim 7 further including a reinforcing layer positioned between the closed cell polymeric foam layers.

12. The concrete form according to claim 11 wherein the reinforcing layer comprising a mesh layer.

13. The concrete form according to claim 11 wherein the reinforcing layer comprising a sheet layer.

14. A expansion joint comprising:
a body of closed cell polymeric foam having a predetermined thickness, a predetermined height, and a predetermined length; and
the body of closed cell polymeric foam having a substantially uniform thickness and a substantially uniform height throughout the entire length thereof.

15. The expansion joint according to claim 14 wherein the closed cell polymeric foam is formed from polyethylene.

16. The expansion joint according to claim 14 wherein the closed cell polymeric foam is formed from polypropylene.

17. The concrete form according to claim 14 wherein the closed cell polymeric foam is formed from a blend of polyethylene and polypropylene.

18. The concrete form according to claim 14 wherein the closed cell polymeric foam is formed from polystyrene.

19. The expansion joint according to claim 14 wherein the body of polymeric foam comprises a unitary structure throughout the entire thickness thereof.

20. The expansion joint according to claim 14 wherein the body of polymeric foam comprises first and second layers formed from the same closed cell polymeric foam material which are joined one to another along the entire length thereof.

21. The concrete form according to claim 20 wherein the first and second layers are formed from the same material.

22. The expansion joint according to claim 20 wherein the layers of polymeric foam are joined one to another by heat sealing.

23. The expansion joint according to claim 20 wherein the layers of polymeric foam are joined one to another by depositing a layer of adhesive material therebetween.

24. The expansion joint according to claim 20 further including a reinforcing layer positioned between the closed cell polymeric foam layers.

25. The expansion joint according to claim 24 wherein the reinforcing layer comprising a mesh layer.

26. The expansion joint according to claim 24 wherein the reinforcing layer comprising a sheet layer.

27. A method of constructing concrete structure comprising:
providing a body of closed cell polymeric foam having a predetermined thickness, a predetermined height, and an indeterminate length;
the body of closed cell polymeric foam having a substantially uniform thickness and a substantially uniform height throughout the entire length thereof; and
utilizing the body of polymeric foam as a concrete form.

28. The method of constructing concrete structures according to claim 27 wherein the closed cell polymeric foam is formed from polyethylene.

29. The method of constructing concrete structures according to claim 27 wherein the closed cell polymeric foam is formed from polypropylene.

30. The concrete form according to claim 27 wherein the closed cell polymeric foam is formed from a blend of polyethylene and polypropylene.

31. The concrete form according to claim 27 wherein the closed cell polymeric foam is formed from polystyrene.

32. The method of constructing concrete structures according to claim 27 wherein the body of polymeric foam comprises a unitary structure throughout the entire thickness thereof.

33. The method of constructing concrete structures according to claim 27 wherein the body of polymeric foam comprises first and second layers formed from closed cell polymeric foam material which are joined one to another along the entire length thereof.

34. The concrete form according to claim 33 wherein the first and second layers are formed from the same material.

35. The method of constructing concrete structures according to claim 33 further including the step of joining the layers of polymeric foam one to another by heat sealing.

36. The method of constructing concrete structures according to claim 33 further including the step of joining the layers of polymeric foam are joined one to another by depositing a layer of adhesive material therebetween.

37. The method of constructing concrete structures according to claim 33 further including a reinforcing layer positioned between the closed cell polymeric foam layers.

38. The method of constructing concrete structures according to claim 37 wherein the reinforcing layer comprises a mesh layer.

39. The method of constructing concrete structures according to claim 37 wherein the reinforcing layer comprises a solid layer.

40. A method of constructing concrete structure comprising:
a body of closed cell polymeric foam having a predetermined thickness, a predetermined height, and a predetermined length;
the body of closed cell polymeric foam having a substantially uniform thickness and a substantially uniform height throughout the entire length thereof; and
utilizing the body of polymeric foam as an expansion joint.

41. The method of constructing concrete structures according to claim 40 wherein the closed cell polymeric foam is formed from polyethylene.

42. The method of constructing concrete structures according to claim 40 wherein the closed cell polymeric foam is formed from polypropylene.

43. The concrete form according to claim 40 wherein the closed cell polymeric foam is formed from a blend of polyethylene and polypropylene.

44. The concrete form according to claim 40 wherein the closed cell polymeric foam is formed from polystyrene.

45. The method of constructing concrete structures according to claim 40 wherein the body of polymeric foam comprises a unitary structure throughout the entire thickness thereof.

46. The method of constructing concrete structures according to claim 40 wherein the body of polymeric foam comprises first and second layers formed from the same closed cell polymeric foam material which are joined one to another along the entire length thereof.

47. The concrete form according to claim 46 wherein the first and second layers are formed from the same material.

48. The method of constructing concrete structures according to claim 46 including the additional step of joining the layers of polymeric foam one to another by heat sealing.

49. The method of constructing concrete structures according to claim 46 including the additional step of joining the layers of polymeric foam one to another by depositing a layer of adhesive material therebetween.

50. The method of constructing concrete structures according to claim 46 further including a reinforcing layer positioned between the closed cell polymeric foam layers.

51. The method of constructing concrete structures according to claim 50 wherein the reinforcing layer comprising a mesh layer.

52. The method of constructing concrete structures according to claim 50 wherein the reinforcing layer comprising a sheet layer.
